(19) United States
(12) Patent Application Publication
(10) Pub. No.: US 2004/0135393 A1
(43) Pub. Date: Jul. 15, 2004

(54) Retractable combination automobile sunshade and luggage carrier

(76) Inventors: Leon Neuer, Petah Tikva (IL); Uzi Kupfer, Petah Tikva (IL)

Correspondence Address: Bernard Malina, Esq., Malina & Wolson, 60 East 42nd Street, New York, NY, 10165-0501, US

(21) Appl. No.: 10/743,905

(22) Filed: Dec. 24, 2003

Related U.S. Application Data
(60) Provisional application No. 60/437,030, filed on Dec. 31, 2002.

(51) Int. Cl. B60J 11/00

(52) U.S. Cl. 296/136.1; 296/98

(57) ABSTRACT

A combination sunshade and luggage carrier which includes four housings, are arranged in a rectangular configuration. Each of the housings contains a flexible sunshade which is mounted on a roller. The housings are mounted on a linkage mechanism which is mounted in the roof of an automobile. The linkage mechanism can move the housings from a storage position in which the housings are in the confines of the automobile roof to an operating position in which the housings are above the roof In the operating position, the sunshades can be extended to protect the automobile from solar heating. Luggage may be placed in a space defined by the housings and lashed to the housing.

### CROSS REFERENCES

Benefit is claimed from Provisional Application Serial No. 60/437,030 filed Dec. 31, 2002.

### FIELD OF THE INVENTION

The present invention relates generally to the field of automotive equipment; more particularly, to a retractable combination automobile sunshade and luggage carrier.

### BACKGROUND OF THE INVENTION

The prior art related to equipment for automobiles includes various examples of carriers which may be attached to the roof of an automobile to aid in the transportation of luggage and other bulky items which cannot fit conveniently in the trunk of an automobile. These luggage carriers are typically attached to the roof of an automobile using various combinations of pads, straps, and clamping devices. The disadvantages associated with the prior art are related to the attachment of the luggage carrier to the roof of the automobile. While pads are typically provided in prior art devices in an attempt to prevent damage to the surface finish on the roof of an automobile, these devices are often not fully effective due to the significant forces which are applied in an effort to achieve secure attachment of the luggage carrier. The various straps and clamps often interfere with the aerodynamic performance of the automobile. When not in use, the conventional luggage carriers must be removed from the automobile roof and stored thereby resulting in a degree of inconvenience.

It is an object of the present invention to provide a combination retractable automobile sunshade and luggage carrier which eliminates the need to remove and store a conventional luggage carrier when not in use.

Another object of the present invention is to provide a combination retractable automobile sunshade and luggage carrier which can be used to reduce the unwanted solar heating of the passenger compartment of an automobile.

Another object of the present invention is to provide a retractable combination sunshade and luggage carrier which eliminates the need to procure, install and store an automobile sunshade and luggage carrier.

Another object of the present invention is to provide a retractable combination sunshade and luggage carrier which can be retracted into the roof of an automobile to preserve the aerodynamic contour of the automobile.

Another object of the present invention is to provide a retractable combination sunshade and luggage carrier which can be used when the automobile is parked in the sun and which can be retracted into the roof of an automobile for normal operation of the automobile.

Yet another object of the present invention is to provide a retractable combination sunshade and luggage carrier which comprises a relatively small number of component parts which can be easily manufactured in volume resulting in a relatively low unit cost.

The foregoing objects and advantages of the invention will appear more clearly hereinafter.

In accordance with the present invention, there is provided a retractable combination automobile sunshade and luggage carrier which includes four elongated housings which are arranged in a rectangular configuration. Each of the housings contains a flexible sunshade which is mounted on a roller which is disposed in the housing. The housings are mounted on a linkage mechanism which is typically mounted in the roof of an automobile. The linkage mechanism can move the housings from a lower or storage position in which the housings are disposed within the confines of the automobile roof to an upper or operating position in which the housings are disposed above the surface of the roof In the operating position, the sunshades can be extended to protect the automobile from solar heating. Luggage can be placed within the open space defined by the housings and lashed to the housings.

When in the storage position, portions of each of the housings form a seal with adjacent portions of the automobile roof.

### BRIEF DESCRIPTION OF THE DRAWINGS

Other important advantages will be apparent from the detailed description taken in connection with the accompanying drawings in which:

FIG. 1 is a fragmentary perspective view of a retractable combination automobile sunshade and luggage carrier shown installed on the roof of an automobile;

FIG. 2 is a schematic cross-sectional view taken along the line 2-2 of FIG. 1;

FIG. 3 is a fragmentary perspective view similar to FIG. 1 with the retractable combination automobile sunshade and luggage carrier shown in the extended position;

FIG. 4 is a schematic cross-sectional view taken along the line 4-4 of FIG. 3;

FIG. 5 is a schematic cross-sectional view of one of the housings 12 of the apparatus 10 of FIG. 1 drawn to an enlarged scale and shown removed from the apparatus;

FIG. 6 is a fragmentary perspective view similar to FIG. 3 showing the sunshades extended;

FIG. 7 is a fragmentary perspective view similar to FIG. 6 showing a sunshade extended to cover the roof of the automobile;

FIG. 8 is a fragmentary cross-sectional schematic view taken along the line 8-8 of FIG. 7;

FIG. 9 is a fragmentary perspective view of an alternative embodiment of the invention shown in FIG. 1;

FIG. 10 is a schematic cross-sectional taken along the line 10-10 of FIG. 9 showing the apparatus in the retracted position;

FIG. 11 is a view similar to FIG. 10 showing the apparatus in the extended position.

### DETAILED DESCRIPTION OF THE INVENTION

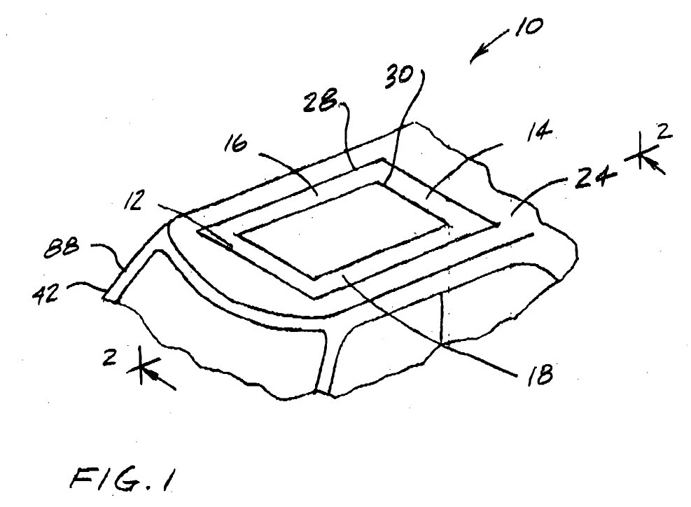

With reference to the drawings, there is shown in FIGS. 1-5 a retractable combination automobile sunshade and luggage carrier 10 made in accordance with the present invention. All of the figures are schematic in nature. The apparatus 10 includes four sunshade housings 12, 14, 16, 18.

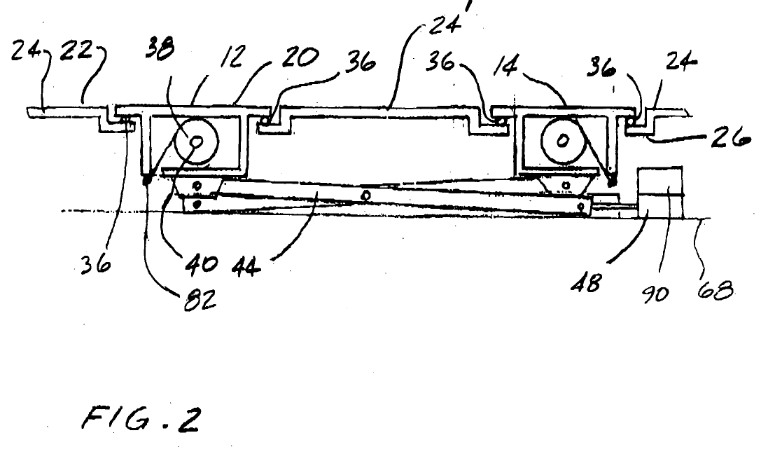

As shown in FIGS. 1 and 2 in the retracted position, the top 20 of the sunshade housings 12, 14, 16, 18 fit flush with the top 22 of the roof 24 and 24′ of an automobile. The roof 24 includes a step portion 26 at each edge 28, 30 of the roof opening 32. In the retracted position, as shown in FIG. 2, a portion 34 of the housings 12, 14, 16, 18 bear against a seal 36 which is mounted on the step portion 26, thereby sealing the internal components of the roof 24. The apparatus 10 includes four similar housings 12, 14, 16, 18, two of which 12, 14 are shown in FIG. 2. The housings 12, 14, 16, 18 each contain a flexible sunshade 38 which is mounted on a roller 40. During use, the sunshades 38 can be unrolled to cover the front and rear windshields 92, 94 and the side 96 windows of the automobile 42.

The apparatus 10 is used as a sunshade only when the automobile 42 is parked in the sun. During travel, the apparatus 10 is stored within the confines of the roof 24 of the automobile 42 and does not interfere with the normal operation of the automobile.

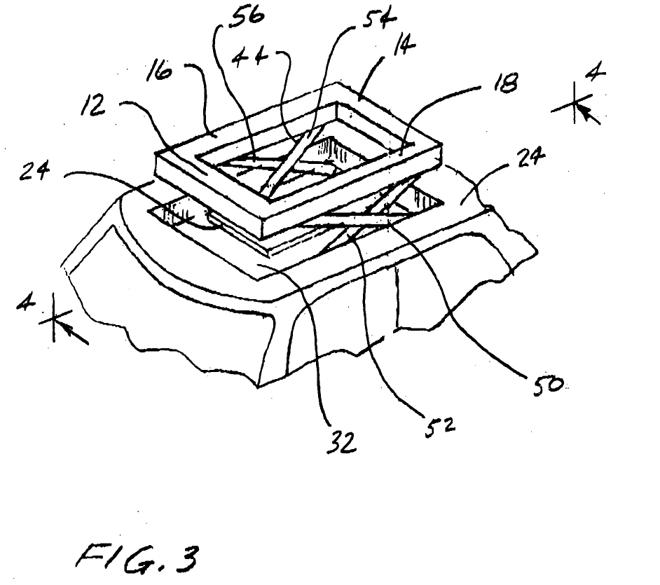

As is shown in FIGS. 2-4, the housings 12, 14, 16, 18 are connected by a scissors-type of linkage mechanism 44. A linear actuator 48 may be a ball screw actuator or a similar device which operates the linkage mechanism 44 to lift the sunshade assembly as is shown in FIG. 3.

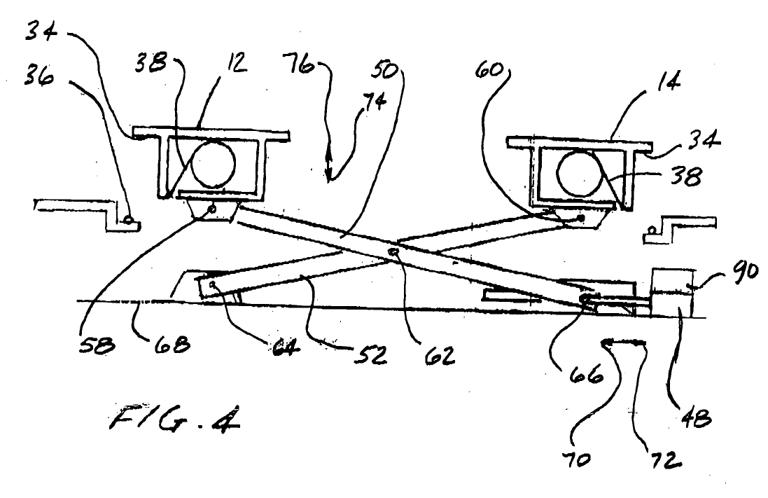

The linkage mechanism 44 includes four link members 50, 52, 54, 56. As is shown typically in FIG. 4, the linkage mechanism includes pivots 58, 60, 62, 64, 66. Pivot 58 connects the link member 50 to the housing 12. Pivot 60 connects the link member 22 to the housing 14. Pivot 62 connects the link members 50, 52 and pivot 64 connects the link member 52 to the automobile structure 68. The pivot 66 connects the link member 50 to the actuator 48.

The motion of the actuator 48 is shown by the arrows 70, 72 in FIG. 4 and the motion of the housings is shown by the arrows 74, 76.

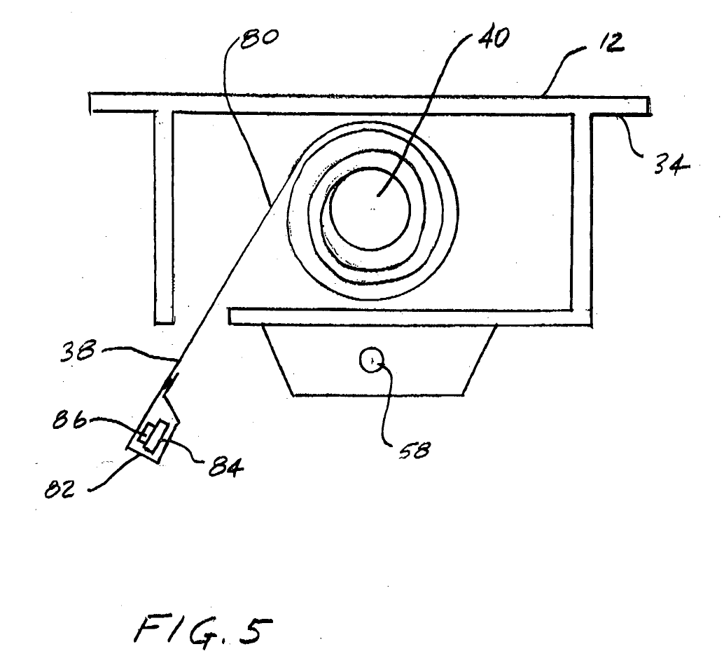

FIG. 5 shows the housing 12 removed from the apparatus 10 and shows the sunshade 38 rolled onto a roller 40. FIG. 5 shows the sunshade partially extended from the housing 12.

As shown typically in FIG. 5, the sunshades 38 are made of a flexible fabric or plastic film 80 and the edge 82 of the sunshades 38 include a stiffener 84 which supports an array of small magnets 86. During operation, the magnets 86 are used to attach the sunshades to the body 88 of the automobile 42.

The actuator 48 is operated by an electric motor 90. The four housings 12, 14, 16, 18 are connected thus forming an open rectangular configuration. Lifting the two housings 12, 14 as shown in FIG. 3 also lifts all four housings 12, 14, 16, 18.

In addition to enclosing and supporting the sunshades, the housings 12, 14, 16, 18 can be used to lash items of luggage or other items on the roof of the automobile 42 thereby functioning as a luggage carrier.

When not in use, the apparatus 10 is retracted within the confines of the roof structure 24 thereby providing a smooth, aerodynamically efficient roof surface.

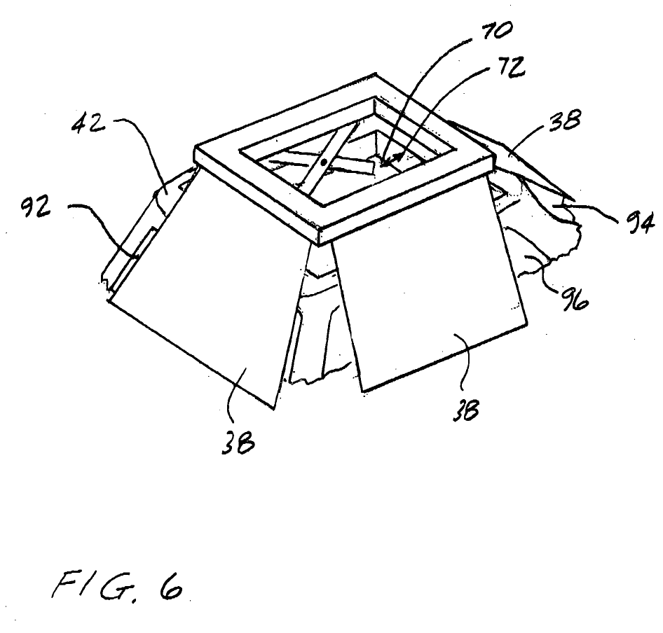

FIG. 6 shows the sunshade 38 extended to cover the front windshield 92 and the rear 94 and side 96 windows of the automobile 42. In FIG. 6, the linear actuator 48 has not been illustrated for purposes of clarity; however, the direction of motion of the actuator has been indicated by the arrows 70, 72.

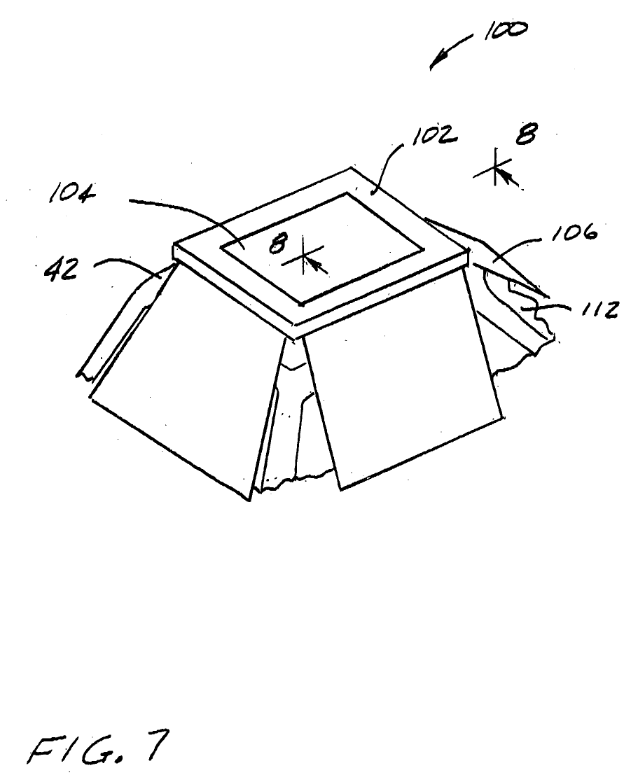

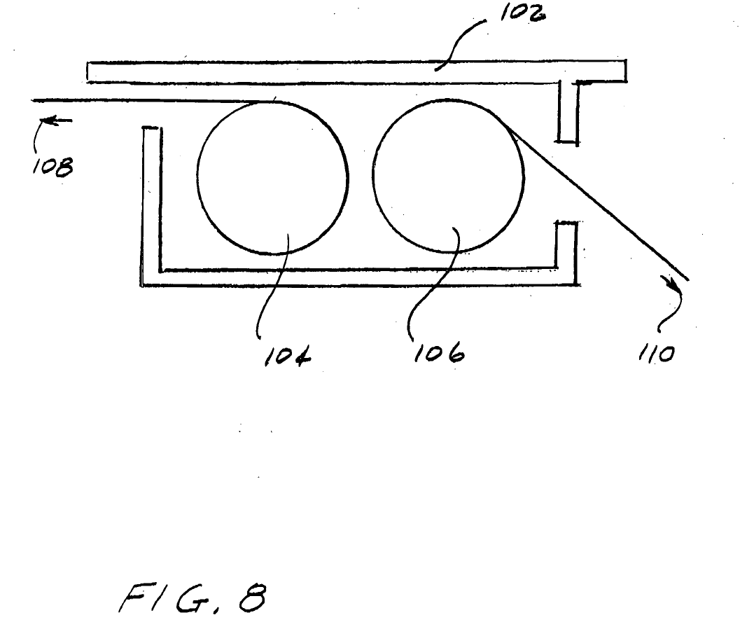

FIGS. 7-8 show an alternative embodiment of the invention 100 in which the housing 102 supports two sunshades 104, 106. As is shown in FIGS. 7-8 during use, the sunshades 104, 106 can be unrolled in the directions shown by the arrows 108, 110 to cover both the rear window 102 and the roof 24, 24′ of the automobile 42.

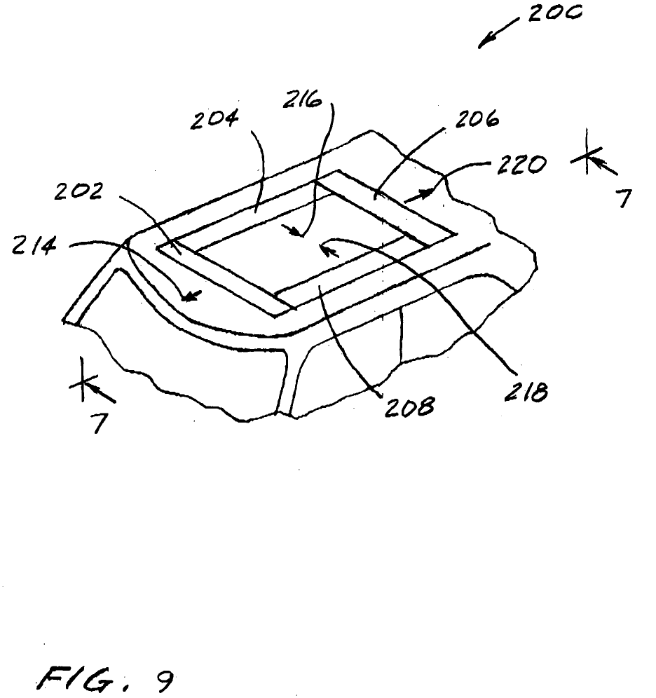

FIGS. 9-11 show a second embodiment of the invention 200 which includes four panels 202, 204, 206, 208 which normally cover openings in the roof 210 of an automobile 212.

As is shown schematically in FIGS. 9-11, the panels 202, 204, 206, 208 move along tracks 210, 212 in the directions shown by the arrows 214, 216, 218, 220 in FIG. 9. The tracks 210, 212 allow the panels 202, 204, 206, 208 to move below the top surface 222 of the roof 224 in the same general manner as in a conventional sun roof in an automobile. The panels may be operated by a conventional cable mechanism (not shown) which is driven by an electric motor or a series of electric motors.

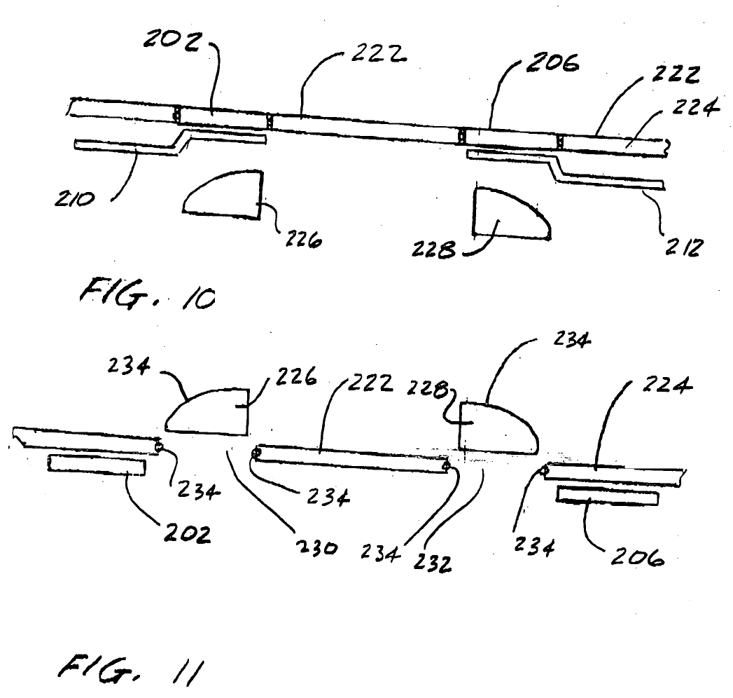

The panels 202, 204, 206, 208 may be opened to reveal four housings two of which 226, 228 are shown in FIG. 10 containing flexible sunshades similar to the housings previously described in connection with FIGS. 1-5. During operation, the housings 226, 228 are raised by a mechanism as previously described or a similar mechanism to a position above the surface 222 of the roof 224 as is shown in FIG. 11.

Because the function of sealing the openings 230, 232 formed in the roof 234 is accomplished by the panels 202, 204, 206, 208 and the seals 234, the housings 226, 228 can be configured with a curved aerodynamic surface 234 as shown in FIGS. 10 and 11.

The foregoing specific embodiments of the present invention are for illustrative purposes only. Various changes and modifications may be made within the spirit and scope of the invention.

What is claimed is:

1. A retractable combination automobile sunshade and luggage carrier comprising at least one housing;
at least one sunshade means mounted in said housing;
at least one retraction means disposed supporting said housing and capable of an extended and raised position and a retracted and lowered position.

2. A retractable combination automobile sunshade and luggage carrier as claimed in claim 1 further comprising seal means mounted on said housing.

3. A retractable combination automobile sunshade and luggage carrier as claimed in claim 1 wherein said retraction means comprises a linkage mechanism.

4. A retractable combination automobile sunshade and luggage carrier as claimed in claim 1 further comprising actuator means connected to said retraction means and capable of reversibly moving said retraction means from said extended position to said retracted position.

5. A retractable combination automobile sunshade and luggage carrier as claimed in claim 1 wherein said sunshade means comprises roller means mounted in said housing and a flexible sunshade mounted on said roller means.

6. A retractable combination automobile sunshade and luggage carrier as claimed in claim 1 further comprising four housings forming a rectangular array.

7. A retractable combination automobile sunshade and luggage carrier as claimed in claim 1 further comprising at least one retractable door panel.

8. A retractable combination automobile sunshade and luggage carrier as claimed in claim 3 further comprising linear actuator means disposed to operate said linkage mechanism.

9. A retractable combination automobile sunshade and luggage carrier as claimed in claim 1 further comprising four retractable door panels capable of an open position and a closed position and forming a rectangular configuration.

10. A retractable combination automobile sunshade and luggage carrier as claimed in FIG. 6 further comprising four sunshade means mounted on each in said four housings.

11. A retractable combination automobile sunshade and luggage carrier as claimed in FIG. 10 further comprising a fifth sunshade means mounted in a selected one of said housings.
